(19) United States
(12) Patent Application Publication
(10) Pub. No.: US 2009/0078675 A1
(43) Pub. Date: Mar. 26, 2009

(54) METHOD OF REMOVING PHOTORESIST

(75) Inventors: Darrell LaRue McReynolds, Balmain (AU); Lakshmi C.S., Balmain (AU); Yao Fu, Balmain (AU); Kia Silverbrook, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 11/861,284

(22) Filed: Sep. 26, 2007

(51) Int. Cl. G11B 5/127

(52) U.S. Cl. 216/27; 216/67

(57) ABSTRACT

A method of photoresist removal is provided. The method employs a plasma formed from a gas chemistry comprising NH₃. The method is particularly suitable for use in MEMS fabrication processes, such as inkjet printhead fabrication.

### COPENDING APPLICATION

The following application has been filed by the applicant simultaneously with the present application:

### MEMS31US

The disclosure of this copending application is incorporated herein by reference. The above application has been identified by its filing docket number, which will be substituted with the corresponding application number once assigned.

### CROSS REFERENCES TO RELATED APPLICATIONS

Various methods, systems and apparatus relating to the present invention are disclosed in the following U.S. patents/patent applications filed by the applicant or assignee of the present invention:

| | | | | | | |
|---|---|---|---|---|---|---|
| 6405055 | 6628430 | 7136186 | 10/920372 | 7145689 | 7130075 | 7081974 |
| 7177055 | 7209257 | 7161715 | 7154632 | 7158258 | 7148993 | 7075684 |
| 7158809 | 11/225172 | 11/474280 | 11/635482 | 11/635526 | 11/650545 | 11/653241 |
| 11/653240 | 11758648 | 7241005 | 7108437 | 6915140 | 6999206 | 7136198 |
| 7092130 | 7249108 | 6566858 | 6331946 | 6246970 | 6442525 | 09/517384 |
| 09/505951 | 6374354 | 7246098 | 6816968 | 6757832 | 6334190 | 6745331 |
| 7249109 | 10/203559 | 7197642 | 7093139 | 10/636263 | 10/636283 | 10/866608 |
| 7210038 | 10/902833 | 10/940653 | 10/942858 | 11/706329 | 11/757385 | 11/758642 |
| 7170652 | 6967750 | 6995876 | 7099051 | 11/107942 | 7193734 | 11/209711 |
| 11/599336 | 7095533 | 6914686 | 7161709 | 7099033 | 11/003786 | 7258417 |
| 11/003418 | 11/003334 | 11/003600 | 11/003404 | 11/003419 | 11/003700 | 7255419 |
| 11/003618 | 7229148 | 7258416 | 11/003698 | 11/003420 | 6984017 | 11/003699 |
| 11/071473 | 11748482 | 11/778563 | 11/779851 | 11/778574 | 11/853816 | 11/853814 |
| 11/853786 | 11/856694 | 11/003463 | 11/003701 | 11/003683 | 11/003614 | 11/003702 |
| 11/003684 | 7246875 | 11/003617 | 11/764760 | 11853777 | 11/293800 | 11/293802 |
| 11/293801 | 11/293808 | 11/293809 | 11/482975 | 11/482970 | 11/482968 | 11/482972 |
| 11/482971 | 11/482969 | 11/097266 | 11/097267 | 11/685084 | 11/685086 | 11/685090 |
| 11/740925 | 11/763444 | 11/763443 | 11/518238 | 11/518280 | 11/518244 | 11/518243 |
| 11/518242 | 11/084237 | 11/084240 | 11/084238 | 11/357296 | 11/357298 | 11/357297 |
| 11/246676 | 11/246677 | 11/246678 | 11/246679 | 11/246680 | 11/246681 | 11/246714 |
| 11/246713 | 11/246689 | 11/246671 | 11/246670 | 11/246669 | 11/246704 | 11/246710 |
| 11/246688 | 11/246716 | 11/246715 | 11/246707 | 11/246706 | 11/246705 | 11/246708 |
| 11/246693 | 11/246692 | 11/246696 | 11/246695 | 11/246694 | 11/482958 | 11/482955 |
| 11/482962 | 11/482963 | 11/482956 | 11/482954 | 11/482974 | 11/482957 | 11/482987 |
| 11/482959 | 11/482960 | 11/482961 | 11/482964 | 11/482965 | 11/482976 | 11/482973 |
| 11/495815 | 11/495816 | 11/495817 | 6227652 | 6213588 | 6213589 | 6231163 |
| 6247795 | 6394581 | 6244691 | 6257704 | 6416168 | 6220694 | 6257705 |
| 6247794 | 6234610 | 6247793 | 6264306 | 6241342 | 6247792 | 6264307 |
| 6254220 | 6234611 | 6302528 | 6283582 | 6239821 | 6338547 | 6247796 |
| 6557977 | 6390603 | 6362843 | 6293653 | 6312107 | 6227653 | 6234609 |
| 6238040 | 6188415 | 6227654 | 6209989 | 6247791 | 6336710 | 6217153 |
| 6416167 | 6243113 | 6283581 | 6247790 | 6260953 | 6267469 | 6588882 |
| 6742873 | 6918655 | 6547371 | 6938989 | 6598964 | 6923526 | 6273544 |
| 6309048 | 6420196 | 6443558 | 6439689 | 6378989 | 6848181 | 6634735 |
| 6299289 | 6299290 | 6425654 | 6902255 | 6623101 | 6406129 | 6505916 |
| 6457809 | 6550895 | 6457812 | 7152962 | 6428133 | 7216956 | 7080895 |
| 11/144844 | 7182437 | 11/599341 | 11/635533 | 11/607976 | 11/607975 | 11/607999 |
| 11/607980 | 11/607979 | 11/607978 | 11/735961 | 11/685074 | 11/696126 | 11/696144 |
| 11/696650 | 11/763446 | 10/407212 | 7252366 | 10/683064 | 10/683041 | 11766713 |
| 11/841647 | 11/482980 | 11/563684 | 11/482967 | 11/482966 | 11/482988 | 11/482989 |
| 11/293832 | 11/293838 | 11/293825 | 11/293841 | 11/293799 | 11/293796 | 11/293797 |
| 11/293798 | 11/124158 | 11/124196 | 11/124199 | 11/124162 | 11/124202 | 11/124197 |
| 11/124154 | 11/124198 | 11/124153 | 11/124151 | 11/124160 | 11/124192 | 11/124175 |
| 11/124163 | 11/124149 | 11/124152 | 11/124173 | 11/124155 | 7236271 | 11/124174 |
| 11/124194 | 11/124164 | 11/124200 | 11/124195 | 11/124166 | 11/124150 | 11/124172 |
| 11/124165 | 11/124186 | 11/124185 | 11/124184 | 11/124182 | 11/124201 | 11/124171 |
| 11/124181 | 11/124161 | 11/124156 | 11/124191 | 11/124159 | 11/124176 | 11/124188 |
| 11/124170 | 11/124187 | 11/124189 | 11/124190 | 11/124180 | 11/124193 | 11/124183 |
| 11/124178 | 11/124177 | 11/124148 | 11/124168 | 11/124167 | 11/124179 | 11/124169 |
| 11/187976 | 11/188011 | 11/188014 | 11/482979 | 11/735490 | 11/853018 | 11/228540 |
| 11/228500 | 11/228501 | 11/228530 | 11/228490 | 11/228531 | 11/228504 | 11/228533 |
| 11/228502 | 11/228507 | 11/228482 | 11/228505 | 11/228497 | 11/228487 | 11/228529 |
| 11/228484 | 11/228489 | 11/228518 | 11/228536 | 11/228496 | 11/228488 | 11/228506 |
| 11/228516 | 11/228526 | 11/228539 | 11/228538 | 11/228524 | 11/228523 | 11/228519 |
| 11/228528 | 11/228527 | 11/228525 | 11/228520 | 11/228498 | 11/228511 | 11/228522 |
| 11/228515 | 11/228537 | 11/228534 | 11/228491 | 11/228499 | 11/228509 | 11/228492 |
| 11/228493 | 11/228510 | 11/228508 | 11/228512 | 11/228514 | 11/228494 | 11/228495 |
| 11/228486 | 11/228481 | 11/228477 | 11/228485 | 11/228483 | 11/228521 | 11/228517 |
| 11/228532 | 11/228513 | 11/228503 | 11/228480 | 11/228535 | 11/228478 | 11/228479 |
| 6087638 | 6340222 | 6041600 | 6299300 | 6067797 | 6286935 | 6044646 |
| 6382769 | 10/868866 | 6787051 | 6938990 | 11/242916 | 11/242917 | 11/144799 |
| 11/198235 | 11/766052 | 7152972 | 11/592996 | 6746105 | 11/763440 | 11/763442 |
| 11/246687 | 11/246718 | 11/246685 | 11/246686 | 11/246703 | 11/246691 | 11/246711 |
| 11/246690 | 11/246712 | 11/246717 | 11/246709 | 11/246700 | 11/246701 | 11/246702 |
| 11/246668 | 11/246697 | 11/246698 | 11/246699 | 11/246675 | 11/246674 | 11/246667 |
| 11/829957 | 11/829960 | 11/829961 | 11/829962 | 11/829963 | 11/829966 | 11/829967 |
| 11/829968 | 11/829969 | 7156508 | 7159972 | 7083271 | 7165834 | 7080894 |
| 7201469 | 7090336 | 7156489 | 10/760233 | 10/760246 | 7083257 | 7258422 |
| 7255423 | 7219980 | 10/760253 | 10/760255 | 10/760209 | 7118192 | 10/760194 |
| 10/760238 | 7077505 | 7198354 | 7077504 | 10/760189 | 7198355 | 10/760232 |
| 10/760231 | 7152959 | 7213906 | 7178901 | 7222938 | 7108353 | 7104629 |
| 11/446227 | 11/454904 | 11/472345 | 11/474273 | 7261401 | 11/474279 | 11/482939 |
| 11/482950 | 11/499709 | 11/592984 | 11/601668 | 11/603824 | 11/601756 | 11/601672 |
| 11/650546 | 11/653253 | 11/706328 | 11/706299 | 11/706965 | 11/737080 | 11/737041 |
| 11/778062 | 11/778566 | 11782593 | 11/246684 | 11/246672 | 11/246673 | 11/246683 |
| 11/246682 | 7246886 | 7128400 | 7108355 | 6991322 | 10/728790 | 7118197 |
| 10/728784 | 10/728783 | 7077493 | 6962402 | 10/728803 | 7147308 | 10/728779 |
| 7118198 | 7168790 | 7172270 | 7229155 | 6830318 | 7195342 | 7175261 |
| 10/773183 | 7108356 | 7118202 | 10/77318 | 67134744 | 10/773185 | 7134743 |
| 7182439 | 7210768 | 10/773187 | 7134745 | 7156484 | 7118201 | 7111926 |
| 10/773184 | 7018021 | 11/060751 | 11/060805 | 11/188017 | 7128402 | 11/298774 |
| 11/329157 | 11/490041 | 11/501767 | 11/499736 | 7246885 | 7229156 | 11/505846 |
| 11/505857 | 11/505856 | 11/524908 | 11/524938 | 7258427 | 11/524912 | 11/592999 |
| 11/592995 | 11/603825 | 11/649773 | 11/650549 | 11/653237 | 11/706378 | 11/706962 |
| 11749118 | 11/754937 | 11749120 | 11/744885 | 11/779850 | 11/765439 | 11842950 |
| 11/839539 | 11/097308 | 11/097309 | 7246876 | 11/097299 | 11/097310 | 11/097213 |
| 11/210687 | 11/097212 | 7147306 | 7261394 | 11/764806 | 11/782595 | 11/482953 |
| 11/482977 | 11/544778 | 11/544779 | 11/764808 | 09/575197 | 7079712 | 6825945 |
| 09/575165 | 6813039 | 6987506 | 7038797 | 6980318 | 6816274 | 7102772 |
| 09/575186 | 6681045 | 6728000 | 7173722 | 7088459 | 09/575181 | 7068382 |
| 7062651 | 6789194 | 6789191 | 6644642 | 6502614 | 6622999 | 6669385 |
| 6549935 | 6987573 | 6727996 | 6591884 | 6439706 | 6760119 | 09/575198 |
| 6290349 | 6428155 | 6785016 | 6870966 | 6822639 | 6737591 | 7055739 |
| 7233320 | 6830196 | 6832717 | 6957768 | 09/575172 | 7170499 | 7106888 |
| 7123239 | 11/066161 | 11/066160 | 11/066159 | 11/066158 | 11/066165 | 10/727181 |
| 10/727162 | 10/727163 | 10/727245 | 7121639 | 7165824 | 7152942 | 10/727157 |
| 7181572 | 7096137 | 10/727257 | 7278034 | 7188282 | 10/727159 | 10/727180 |
| 10/727179 | 10/727192 | 10/727274 | 10/727164 | 10/727161 | 10/727198 | 10/727158 |
| 10/754536 | 10/754938 | 10/727227 | 10/727160 | 10/934720 | 7171323 | 11/272491 |
| 11/474278 | 11/488853 | 11/488841 | 11749750 | 11749749 | 10/296522 | 6795215 |
| 7070098 | 7154638 | 6805419 | 6859289 | 6977751 | 6398332 | 6394573 |
| 6622923 | 6747760 | 6921144 | 10/884881 | 7092112 | 7192106 | 11/039866 |
| 7173739 | 6986560 | 7008033 | 11/148237 | 7222780 | 11/248426 | 11/478599 |
| 11/499749 | 11/738518 | 11/482981 | 11/743661 | 11/743659 | 11/752900 | 7195328 |
| 7182422 | 11/650537 | 11/712540 | 10/854521 | 10/854522 | 10/854488 | 10/854487 |
| 10/854503 | 10/854504 | 10/854509 | 7188928 | 7093989 | 10/854497 | 10/854495 |
| 10/854498 | 10/854511 | 10/854512 | 10/854525 | 10/854526 | 10/854516 | 10/854508 |
| 7252353 | 10/854515 | 7267417 | 10/854505 | 10/854493 | 7275805 | 10/854489 |
| 10/854490 | 10/854492 | 10/854491 | 10/854528 | 10/854523 | 10/854527 | 10/854524 |
| 10/854520 | 10/854514 | 10/854519 | 10/854513 | 10/854499 | 10/854501 | 7266661 |
| 7243193 | 10/854518 | 10/854517 | 10/934628 | 7163345 | 11/499803 | 11/601757 |
| 11/706295 | 11/735881 | 11748483 | 11749123 | 11/766061 | 11775135 | 11772235 |
| 11/778569 | 11/829942 | 11/014731 | 11/544764 | 11/544765 | 11/544772 | 11/544773 |
| 11/544774 | 11/544775 | 11/544776 | 11/544766 | 11/544767 | 11/544771 | 11/544770 |
| 11/544769 | 11/544777 | 11/544768 | 11/544763 | 11/293804 | 11/293840 | 11/293803 |
| 11/293833 | 11/293834 | 11/293835 | 11/293836 | 11/293837 | 11/293792 | 11/293794 |
| 11/293839 | 11/293826 | 11/293829 | 11/293830 | 11/293827 | 11/293828 | 11/293795 |
| 11/293823 | 11/293824 | 11/293831 | 11/293815 | 11/293819 | 11/293818 | 11/293817 |
| 11/293816 | 11/838875 | 11/482978 | 11/640356 | 11/640357 | 11/640358 | 11/640359 |
| 11/640360 | 11/640355 | 11/679786 | 10/760254 | 10/760210 | 10/760202 | 7201468 |
| 10/760198 | 10/760249 | 7234802 | 10/760196 | 10/760247 | 7156511 | 10/760264 |
| 7258432 | 7097291 | 10/760222 | 10/760248 | 7083273 | 10/760192 | 10/760203 |
| 10/760204 | 10/760205 | 10/760206 | 10/760267 | 10/760270 | 7198352 | 10/760271 |
| 10/760275 | 7201470 | 7121655 | 10/760184 | 7232208 | 10/760186 | 10/760261 |
| 7083272 | 11/501771 | 11/583874 | 11/650554 | 11/706322 | 11/706968 | 11/749119 |
| 11779848 | 11/855152 | 11855151 | 11/014764 | 11/014763 | 11/014748 | 11/014747 |
| 11/014761 | 11/014760 | 11/014757 | 11/014714 | 7249822 | 11/014762 | 11/014724 |
| 11/014723 | 11/014756 | 11/014736 | 11/014759 | 11/014758 | 11/014725 | 11/014739 |
| 11/014738 | 11/014737 | 11/014726 | 11/014745 | 11/014712 | 11/014715 | 11/014751 |
| 11/014735 | 11/014734 | 11/014719 | 11/014750 | 11/014749 | 7249833 | 11/758640 |
| 11/775143 | 11/838877 | 11/014769 | 11/014729 | 11/014743 | 11/014733 | 11/014754 |
| 11/014755 | 11/014765 | 11/014766 | 11/014740 | 11/014720 | 11/014753 | 7255430 |
| 11/014744 | 11/014741 | 11/014768 | 11/014767 | 11/014718 | 11/014717 | 11/014716 |
| 11/014732 | 11/014742 | 11/097268 | 11/097185 | 11/097184 | 11/778567 | 11852958 |
| 11852907 | 11/293820 | 11/293813 | 11/293822 | 11/293812 | 11/293821 | 11/293814 |
| 11/293793 | 11/293842 | 11/293811 | 11/293807 | 11/293806 | 11/293805 | 11/293810 |
| 11/688863 | 11/688864 | 11/688865 | 11/688866 | 11/688867 | 11/688868 | 11/688869 |
| 11/688871 | 11/688872 | 11/688873 | 11/741766 | 11/482982 | 11/482983 | 11/482984 |
| 11/495818 | 11/495819 | 11/677049 | 11/677050 | 11/677051 | 11/014722 | 10/760180 |
| 7111935 | 10/760213 | 10/760219 | 10/760237 | 7261482 | 10/760220 | 7002664 |
| 10/760252 | 10/760265 | 7088420 | 11/446233 | 11/503083 | 11/503081 | 11/516487 |
| 11/599312 | 11/014728 | 11/014727 | 7237888 | 7168654 | 7201272 | 6991098 |
| 7217051 | 6944970 | 10/760215 | 7108434 | 10/760257 | 7210407 | 7186042 |
| 10/760266 | 6920704 | 7217049 | 10/760214 | 10/760260 | 7147102 | 10/760269 |
| 7249838 | 10/760241 | 10/962413 | 10/962427 | 7261477 | 7225739 | 10/962402 |
| 10/962425 | 10/962428 | 7191978 | 10/962426 | 10/962409 | 10/962417 | 10/962403 |
| 7163287 | 7258415 | 10/962523 | 7258424 | 10/962410 | 7195412 | 7207670 |
| 11/282768 | 7220072 | 11/474267 | 11/544547 | 11/585925 | 11/593000 | 11/706298 |
| 11/706296 | 11/706327 | 11/730760 | 11/730407 | 11/730787 | 11/735977 | 11/736527 |
| 11/753566 | 11/754359 | 11/778061 | 11/765398 | 11/778556 | 11/829937 | 11/780470 |
| 11/223262 | 11/223018 | 11/223114 | 11/223022 | 11/223021 | 11/223020 | 11/223019 |
| 11/014730 | 7154626 | 7079292 | 11/604316 | | | |

### FIELD OF THE INVENTION

The present invention relates to the field of printers and particularly MEMS inkjet printheads. It has been developed primarily to improve fabrication of MEMS inkjet printheads, although the invention is equally applicable to any MEMS fabrication process.

### BACKGROUND OF THE INVENTION

Many different types of printing have been invented, a large number of which are presently in use. The known forms of print have a variety of methods for marking the print media with a relevant marking media. Commonly used forms of printing include offset printing, laser printing and copying devices, dot matrix type impact printers, thermal paper printers, film recorders, thermal wax printers, dye sublimation printers and ink jet printers both of the drop on demand and continuous flow type. Each type of printer has its own advantages and problems when considering cost, speed, quality, reliability, simplicity of construction and operation etc.

In recent years, the field of ink jet printing, wherein each individual pixel of ink is derived from one or more ink nozzles has become increasingly popular primarily due to its inexpensive and versatile nature.

Many different techniques on ink jet printing have been invented. For a survey of the field, reference is made to an article by J Moore, “Non-Impact Printing: Introduction and Historical Perspective”, Output Hard Copy Devices, Editors R Dubeck and S Sherr, pages 207-220 (1988).

Ink Jet printers themselves come in many different types. The utilization of a continuous stream of ink in ink jet printing appears to date back to at least 1929 wherein U.S. Pat. No. 1,941,001 by Hansell discloses a simple form of continuous stream electro-static ink jet printing.

U.S. Pat. No. 3,596,275 by Sweet also discloses a process of a continuous ink jet printing including the step wherein the ink jet stream is modulated by a high frequency electro-static field so as to cause drop separation. This technique is still utilized by several manufacturers including Elmjet and Scitex (see also U.S. Pat. No. 3,373,437 by Sweet et al)

Piezoelectric ink jet printers are also one form of commonly utilized ink jet printing device. Piezoelectric systems are disclosed by Kyser et. al. in U.S. Pat. No. 3,946,398 (1970) which utilizes a diaphragm mode of operation, by Zolten in U.S. Pat. No. 3,683,212 (1970) which discloses a squeeze mode of operation of a piezoelectric crystal, Stemme in U.S. Pat. No. 3,747,120 (1972) discloses a bend mode of piezoelectric operation, Howkins in U.S. Pat. No. 4,459,601 discloses a piezoelectric push mode actuation of the ink jet stream and Fischbeck in U.S. Pat. No. 4,584,590 which discloses a shear mode type of piezoelectric transducer element.

Recently, thermal ink jet printing has become an extremely popular form of ink jet printing. The ink jet printing techniques include those disclosed by Endo et al in GB 2007162 (1979) and Vaught et al in U.S. Pat. No. 4,490,728. Both the aforementioned references disclosed ink jet printing techniques that rely upon the activation of an electrothermal actuator which results in the creation of a bubble in a constricted space, such as a nozzle, which thereby causes the ejection of ink from an aperture connected to the confined space onto a relevant print media. Printing devices utilizing the electro-thermal actuator are manufactured by manufacturers such as Canon and Hewlett Packard.

As can be seen from the foregoing, many different types of printing technologies are available. Ideally, a printing technology should have a number of desirable attributes. These include inexpensive construction and operation, high speed operation, safe and continuous long term operation etc. Each technology may have its own advantages and disadvantages in the areas of cost, speed, quality, reliability, power usage, simplicity of construction operation, durability and consumables.

The present Applicant has developed a plethora of inkjet printheads fabricated by MEMS techniques. Typically, MEMS fabrication employs a plurality of photoresist deposition and removal steps. Removal of relatively thin layers of photoresist (c.a. 1 micron or less), used as photolithographic masks, is usually facile. Standard conditions employ an oxygen plasma, which oxidatively removes any photoresist in a process colloquially known in the art as “ashing”.

In the fabrication of inkjet nozzle assemblies, the present Applicant has employed photoresist as a sacrificial scaffold onto which other materials (e.g. heater material, roof structures) may be deposited. This technique enables relatively complex nozzle assemblies to be constructed. However, it requires deposition of relatively thick layers of viscous, heat-resistant photoresist. As will be explained in more detail below, photoresist layers or plugs of up to 30 microns may be required. Furthermore, this photoresist must be thoroughly hardbaked and UV cured so that it does not reflow during subsequent high-temperature deposition steps e.g. deposition of metals or ceramic material onto the photoresist.

In a typical MEMS printhead fabrication process, a final ashing step removes all remaining photoresist in the nozzle assemblies, including photoresist scaffolds and photoresist plugs employed during the fabrication process. Hitherto, traditional O₂ plasma ashing techniques have been employed for final or late-stage removal of photoresist.

However, thick layers of photoresist, which have been hardbaked and UV cured have increased resistance to ashing and are removed relatively slowly by traditional O₂ ashing techniques. This means that prolonged ashing times are required and/or higher ashing temperatures. Prolonged ashing times and/or higher ashing temperatures are undesirable, because there is an increased risk of damage to other MEMS structures (e.g. nozzle chambers, actuators) during the ashing process. Moreover, there is, in general, a need to increase the efficiency of each MEMS processing step so as to reduce processing time and, ultimately, reduce the cost of each printhead.

The addition of small amounts of fluorine-containing gases (e.g. CF₄, C₄F₈) is known to increase the rate of O₂ ashing. However, fluorinated gas chemistries attack materials such as silicon nitride, which typically forms the nozzle plate in the Applicant's MEMS printheads. Accordingly, these ashing conditions are not considered suitable for use in the Applicant's fabrication process.

The use of O₂/N₂ has also been used to improve ashing rates, although the addition of N₂ shows only moderate improvement over pure O₂.

Accordingly, from the foregoing, it will be appreciated that there is a need to improve the efficiency of photoresist removal in MEMS fabrication techniques. Whilst this need has been presented in the context of printhead fabrication, it will be appreciated that any MEMS fabrication process would benefit from improved techniques for photoresist removal, especially those MEMS fabrication processes which use a relatively thick layer of sacrificial photoresist, which has been hardbaked and/or UV cured.

### SUMMARY OF THE INVENTION

In a first embodiment, there is provided a method of photoresist removal, the method employing a plasma formed from a gas chemistry comprising NH₃. The present inventors have found that gas chemistries comprising NH₃ are particularly efficacious in removing photoresist and provide higher ashing rates than conventional O₂ ashing. Typically ashing rates are improved by at least 20%, at least 50% or at least 100%, compared with ashing rates using a conventional O₂ plasma.

In some embodiments, the gas chemistry consists of NH₃ only.

In other embodiments, the gas chemistry further comprises O₂. The O₂ may be a major or a minor component of the gas chemistry.

Optionally a ratio of O₂:NH₃ is in the range of 15:1 to 5: 1, or optionally about 10:1.

Optionally, the gas chemistry consists of O₂ and NH₃.

Optionally, the gas chemistry further comprises N₂.

Optionally a ratio of N₂:NH₃ is in the range of 5:1 to 1:5, or optionally about 1:1.

Optionally, the gas chemistry consists of O₂, NH₃ and N₂, and optionally in a ratio of about 10:1:1.

Optionally, the photoresist is hardbaked photoresist. Optionally, the photoresist is UV-cured photoresist. Optionally, the photoresist has a thickness of at least 2 microns or at least 5 microns. Traditionally, photoresist of this nature was considered relatively difficult to remove and required prolonged ashing times. However, the present invention removes such photoresist in acceptable times with no damage to other MEMS structures.

Optionally, the method is a step of a MEMS fabrication process.

Optionally, the method is a step of a printhead fabrication process.

Optionally, the photoresist is contained in at least one of: inkjet nozzle chambers and ink supply channels. This photoresist may be used as a sacrificial scaffold during nozzle fabrication, but requires removal in late-stage MEMS processing.

Optionally, the photoresist is a protective coating for MEMS structures, such as inkjet nozzle assemblies. Typically, MEMS structures are protected with a hardbaked photoresist layer during MEMS fabrication, especially if backside processing steps are required. The present invention is suitable for removing such photoresist.

In a second aspect, there is provided a method of fabricating an inkjet printhead, the method comprising the steps of:

forming inkjet nozzle chambers on a substrate, each nozzle chamber containing at least some photoresist; and

removing said photoresist using a plasma formed from a gas chemistry comprising NH₃.

### BRIEF DESCRIPTION OF THE DRAWINGS

Optional embodiments of the present invention will now be described by way of example only with reference to the accompanying drawings, in which:

FIG. 1 is a partial perspective view of an array of nozzle assemblies of a thermal inkjet printhead;

FIG. 2 is a side view of a nozzle assembly unit cell shown in FIG. 1;

FIG. 3 is a perspective of the nozzle assembly shown in FIG. 2;

FIG. 4 shows a partially-formed nozzle assembly after deposition of side walls and roof material onto a sacrificial photoresist layer;

FIG. 5 is a perspective of the nozzle assembly shown in FIG. 4;

FIG. 6 is the mask associated with the nozzle rim etch shown in FIG. 7;

FIG. 7 shows the etch of the roof layer to form the nozzle opening rim;

FIG. 8 is a perspective of the nozzle assembly shown in FIG. 7;

FIG. 9 is the mask associated with the nozzle opening etch shown in FIG. 10;

FIG. 10 shows the etch of the roof material to form the elliptical nozzle openings;

FIG. 11 is a perspective of the nozzle assembly shown in FIG. 10;

FIG. 12 shows the nozzle assembly after plasma ashing of the sacrificial photoresist;

FIG. 13 is a perspective of the nozzle assembly shown in FIG. 12;

FIG. 14 shows the whole thickness of the wafer after plasma ashing;

FIG. 15 is a perspective of the nozzle assembly shown in FIG. 14;

FIG. 16 is the mask associated with the backside etch shown in FIG. 17;

FIG. 17 shows the backside etch of the ink supply channel into the wafer; and

FIG. 18 is a perspective of the nozzle assembly shown in FIG. 17.

### DESCRIPTION OF OPTIONAL EMBODIMENTS

As foreshadowed above, the present invention may be used in connection with any process requiring removal of photoresist. However, it will now be exemplified using the example of MEMS inkjet printhead fabrication. The present Applicant has previously described a fabrication of a plethora of inkjet printheads for which the present invention is suitable. It is not necessary to describe all such printheads here for an understanding of the present invention. However, the present invention will now be described in connection with a thermal bubble-forming inkjet printhead and a mechanical thermal bend actuated inkjet printhead. Advantages of the present invention will be readily apparent from the discussion that follows.

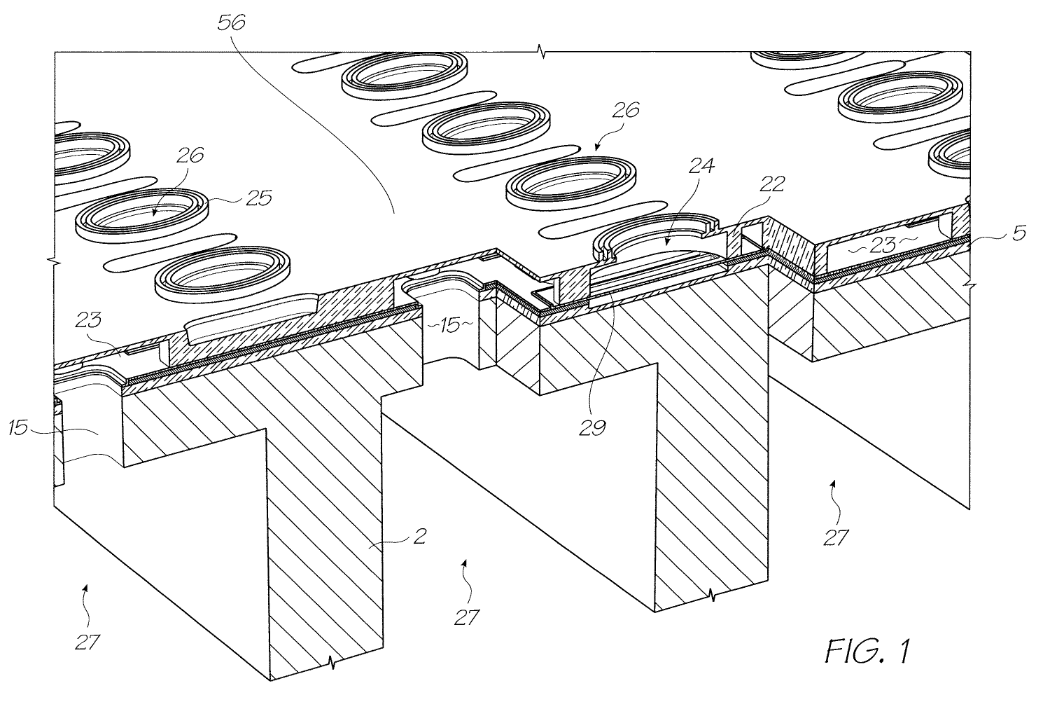

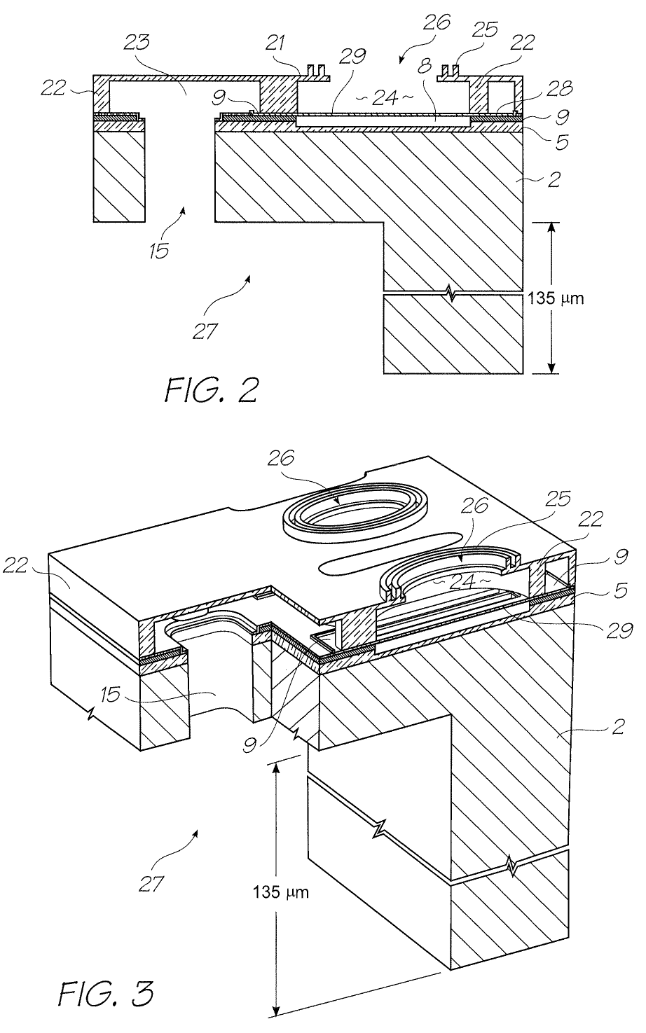

Referring to FIG. 1, there is shown a part of printhead comprising a plurality of nozzle assemblies. FIGS. 2 and 3 show one of these nozzle assemblies in side-section and cutaway perspective views.

Each nozzle assembly comprises a nozzle chamber 24 formed by MEMS fabrication techniques on a silicon wafer substrate 2. The nozzle chamber 24 is defined by a roof 21 and sidewalls 22 which extend from the roof 21 to the silicon substrate 2. As shown in FIG. 1, each roof is defined by part of a nozzle plate 56, which spans across an ejection face of the printhead. The nozzle plate 56 and sidewalls 22 are formed of the same material, which is deposited by PECVD over a sacrificial scaffold of photoresist during MEMS fabrication. Typically, the nozzle plate 56 and sidewalls 21 are formed of a ceramic material, such as silicon dioxide or silicon nitride. These hard materials have excellent properties for printhead robustness, and their inherently hydrophilic nature is advantageous for supplying ink to the nozzle chambers 24 by capillary action.

Returning to the details of the nozzle chamber 24, it will be seen that a nozzle opening 26 is defined in a roof of each nozzle chamber 24. Each nozzle opening 26 is generally elliptical and has an associated nozzle rim 25. The nozzle rim 25 assists with drop directionality during printing as well as reducing, at least to some extent, ink flooding from the nozzle opening 26. The actuator for ejecting ink from the nozzle chamber 24 is a heater element 29 positioned beneath the nozzle opening 26 and suspended across a pit 8. Current is supplied to the heater element 29 via electrodes 9 connected to drive circuitry in underlying CMOS layers of the substrate 2. When a current is passed through the heater element 29, it rapidly superheats surrounding ink to form a gas bubble, which forces ink through the nozzle opening. By suspending the heater element 29, it is completely immersed in ink when the nozzle chamber 24 is primed. This improves printhead efficiency, because less heat dissipates into the underlying substrate 2 and more input energy is used to generate a bubble.

As seen most clearly in FIG. 1, the nozzles are arranged in rows and an ink supply channel 27 extending longitudinally along the row supplies ink to each nozzle in the row. The ink supply channel 27 delivers ink to an ink inlet passage 15 for each nozzle, which supplies ink from the side of the nozzle opening 26 via an ink conduit 23 in the nozzle chamber 24.

The complete MEMS fabrication process for manufacturing such printheads was described in detail in our previously filed U.S. application Ser. No. 11/246,684 filed on Oct. 11, 2005, the contents of which is herein incorporated by reference. The latter stages of this fabrication process are briefly revisited here so as to illustrate one example of the present invention.

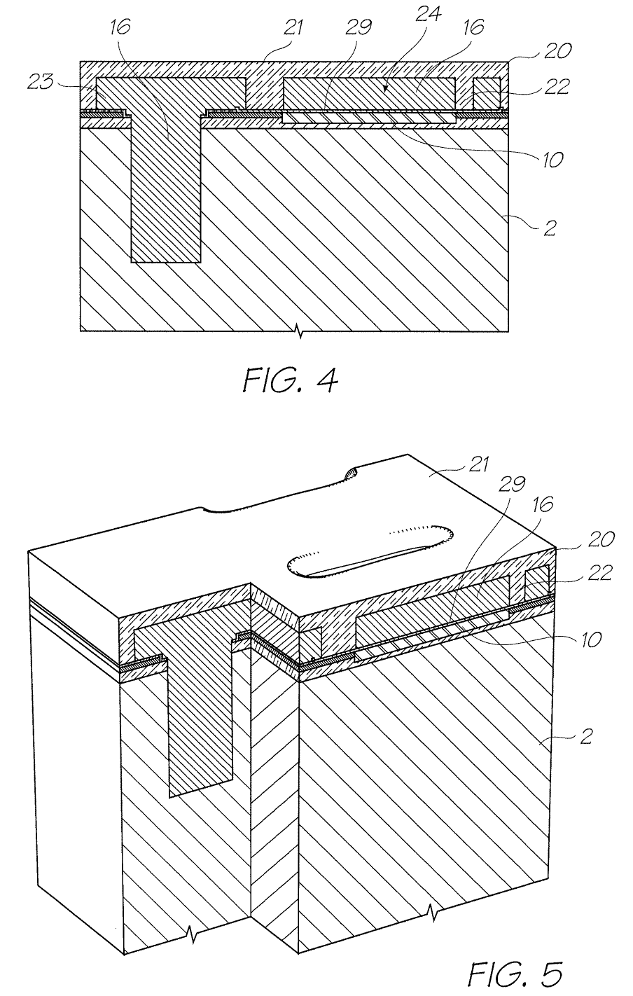

FIGS. 4 and 5 show a partially-fabricated printhead comprising a nozzle chamber 24 encapsulating sacrificial photoresist 16. During nozzle fabrication, the photoresist 16 was used firstly to plug the ink inlet 15 (shown in FIG. 2), secondly as a scaffold for deposition of heater material to form the suspended heater element 29, and thirdly as a scaffold for deposition of the sidewalls 22 and roof 21 (which defines part of the nozzle plate 56). The photoresist plugging the ink inlet 15 has a depth of about 20 microns, while the photoresist used as a scaffold in the nozzle chambers has a thickness of at least 5 microns. Furthermore, all the photoresist 16 was hardbaked and UV cured and must be removed later on in the fabrication process.

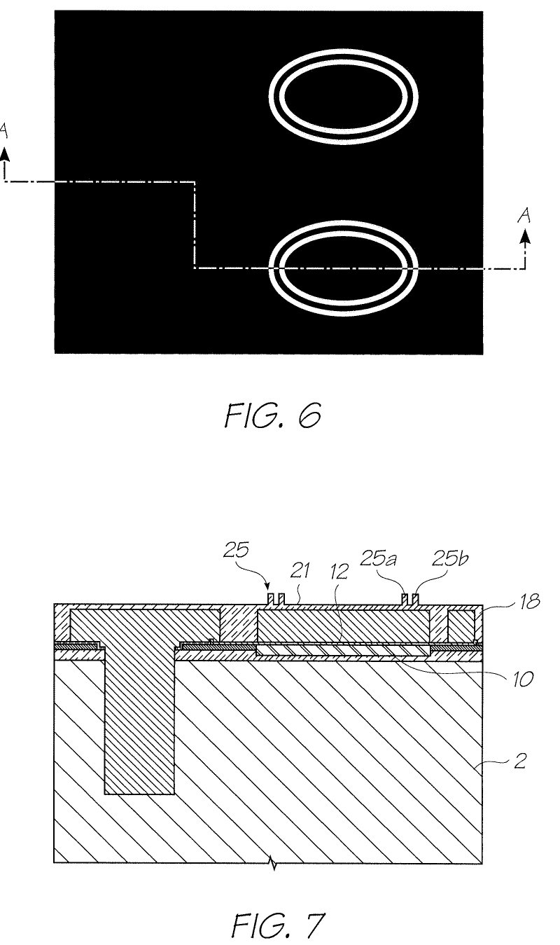

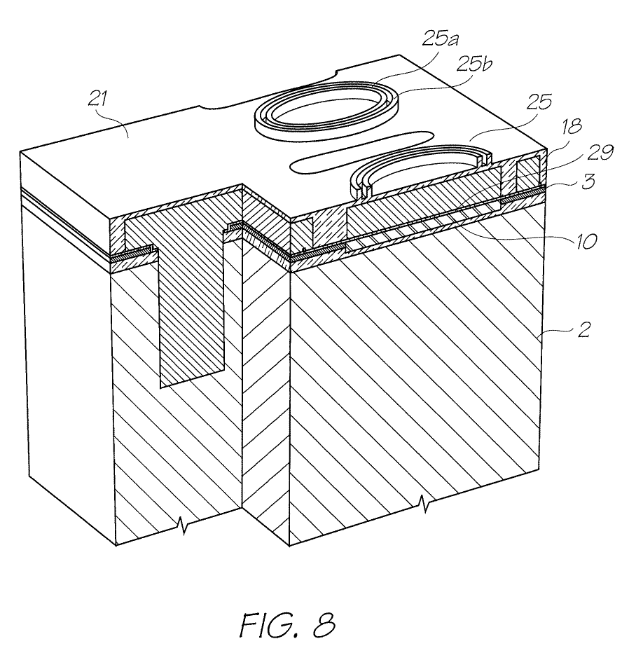

Referring to FIGS. 6 to 8, the next stage of MEMS fabrication defines the elliptical nozzle rim 25 in the roof 21 by etching away 2 microns of roof material 20. This etch is defined using a layer of photoresist (not shown) exposed by the dark tone rim mask shown in FIG. 6. The elliptical rim 25 comprises two coaxial rim lips 25a and 25b, positioned over their respective thermal actuator 29.

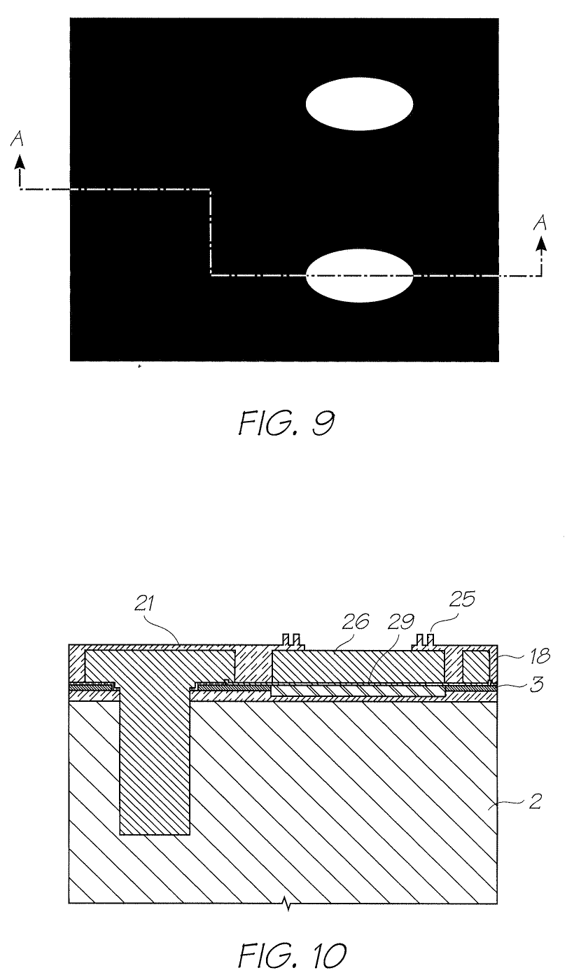

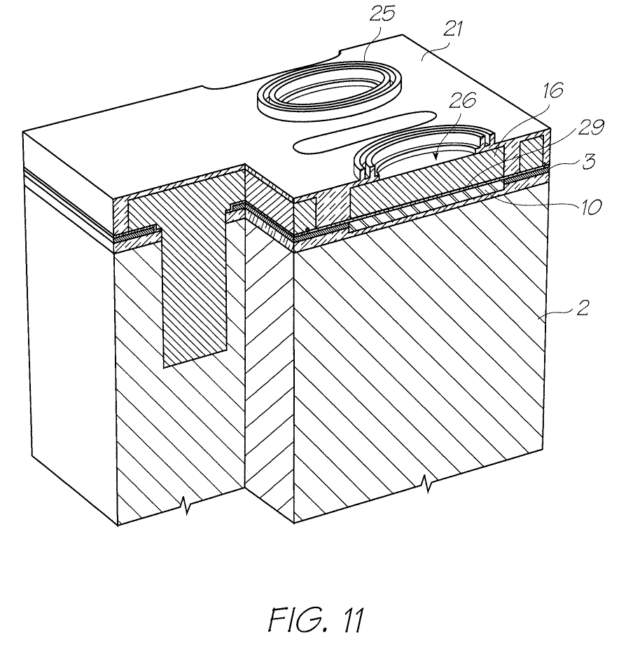

Referring to FIGS. 9 to 11, the next stage defines an elliptical nozzle aperture 26 in the roof 21 by etching all the way through the remaining roof material 20, which is bounded by the rim 25. This etch is defined using a layer of photoresist (not shown) exposed by the dark tone roof mask shown in FIG. 9. The elliptical nozzle aperture 26 is positioned over the thermal actuator 29, as shown in FIG. 11.

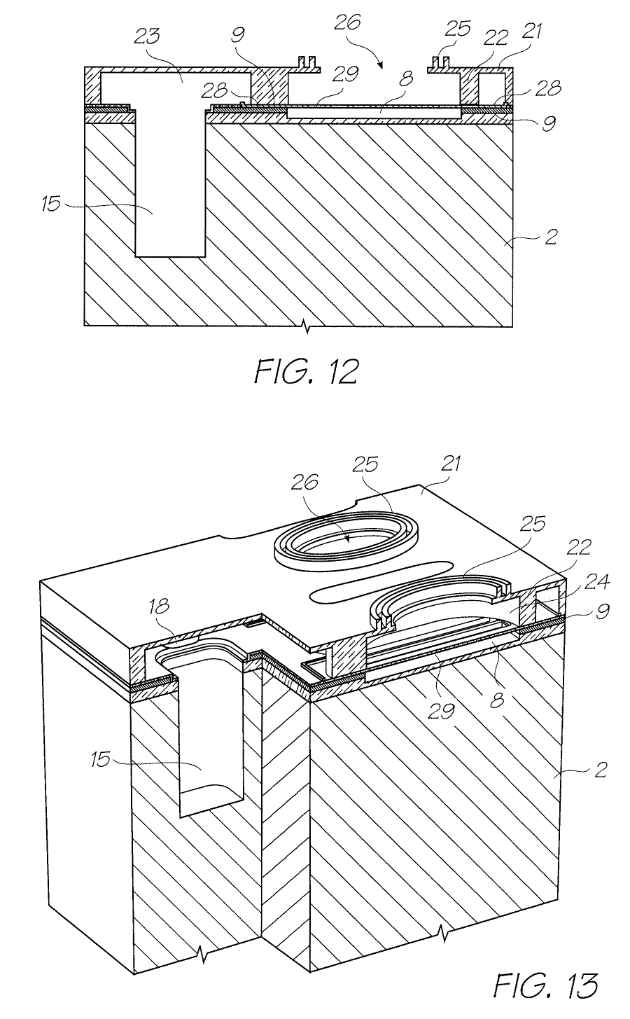

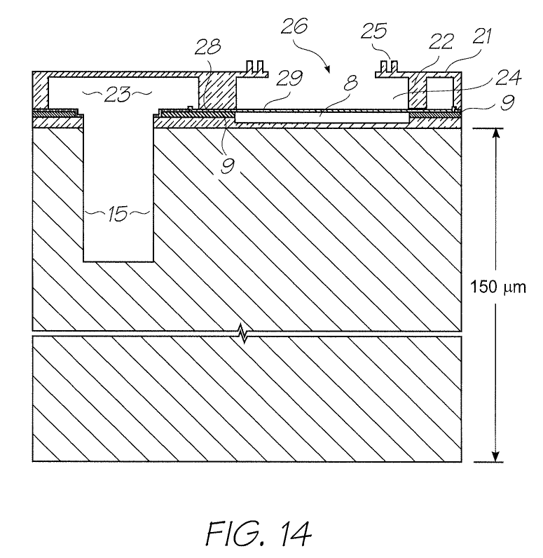

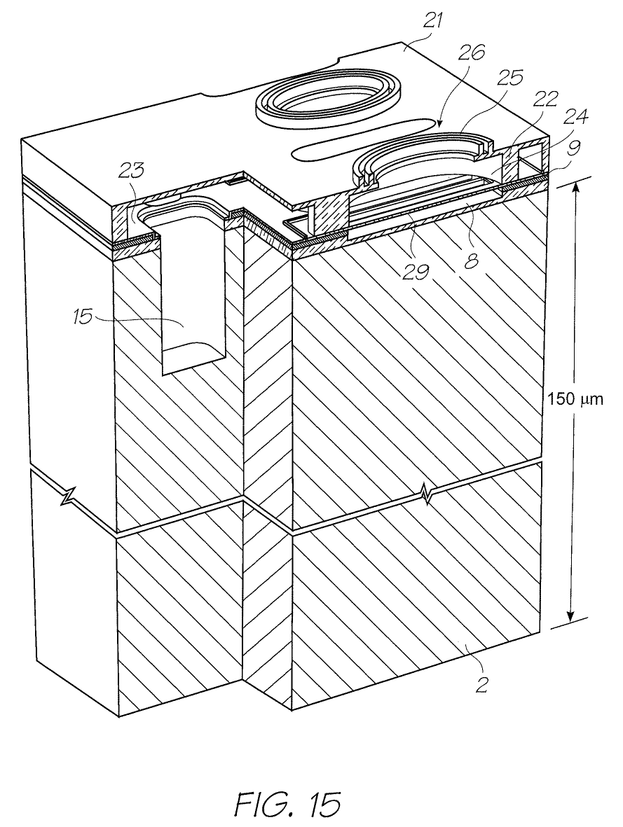

With all the MEMS nozzle features now fully formed, the next stage removes the photoresist 16 by frontside plasma ashing (FIGS. 12 and 13). FIGS. 14 and 15 show the entire thickness (150 microns) of the silicon wafer 2 after ashing away all the photoresist 16.

In a traditional ashing processes, an O₂ plasma is employed for ashing the photoresist 16. However, in accordance with the present invention, the ashing plasma is formed using a gas chemistry comprising NH₃. When the plasma is formed from a gas chemistry comprising NH₃, superior ashing is achieved in terms of increased ashing rate and reduced damage to nozzle structures. Experimental details of ashing conditions are described in more detail in the Example section below.

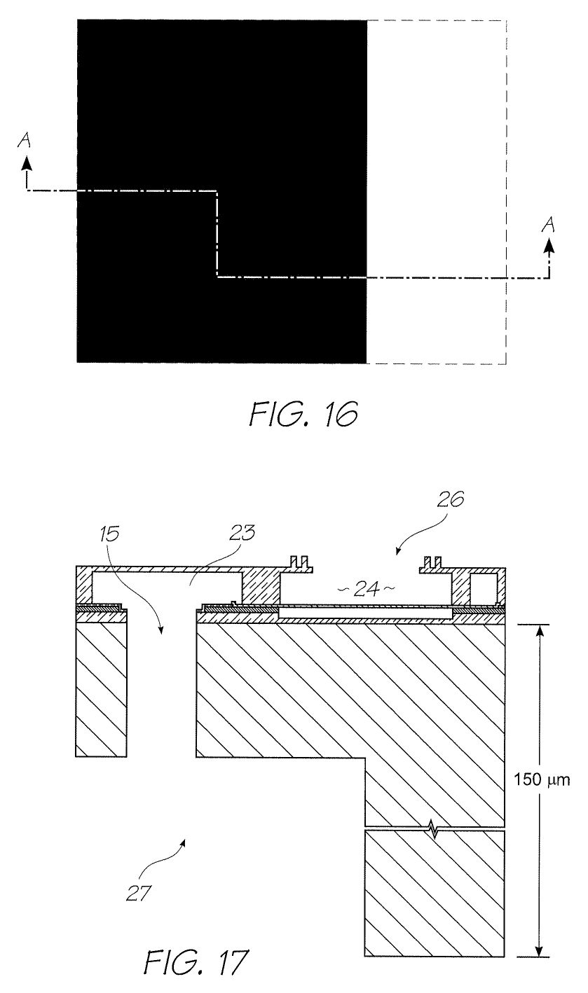

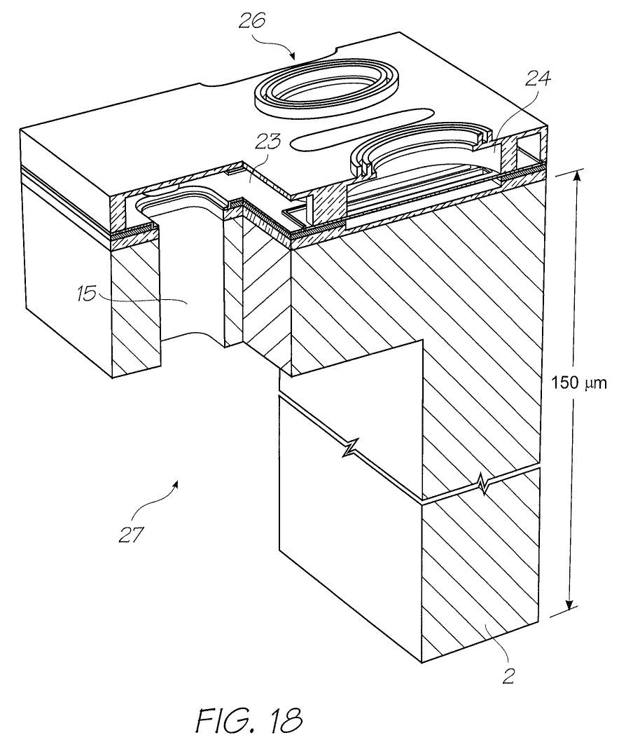

Referring to FIGS. 16 to 18, once frontside MEMS processing of the wafer is completed, ink supply channels 27 are etched from the backside of the wafer to meet with the ink inlets 15 using a standard anisotropic DRIE. This backside etch is defined using a layer of photoresist (not shown) exposed by the dark tone mask shown in FIG. 16. The ink supply channel 27 makes a fluidic connection between the backside of the wafer and the ink inlets 15.

Finally, and referring to FIGS. 2 and 3, the wafer is thinned to about 135 microns by backside etching. FIG. 1 shows three adjacent rows of nozzles in a cutaway perspective view of a completed printhead integrated circuit. Each row of nozzles has a respective ink supply channel 27 extending along its length and supplying ink to a plurality of ink inlets 15 in each row. The ink inlets, in turn, supply ink to the ink conduit 23 for each row, with each nozzle chamber receiving ink from a common ink conduit for that row.

It will be appreciated by the person skilled in the art that the exact ordering of late-stage MEMS fabrication steps may be varied. For example, backside ashing may be performed after the ink supply channels 27 have been etched. Alternatively, both frontside and backside ashing may be employed so as to completely remove the photoresist, whilst minimizing risk of damage to nozzle stuctures. Regardless, it will be appreciated that the wafer must be subjected to ashing, either frontside ashing and/or backside ashing, in order to remove the photoresist 16 and furnish the printhead.

### EXAMPLES

Frontside ashing of the nozzle assembly shown in FIGS. 10 and 11 was performed in an ashing oven, using Recipes 1 to 3 shown in Table 1. The temperature in Table 1 refers to the chuck temperature, which is cooled using helium.

TABLE 1

| | Recipe 1 | Recipe 2 | Recipe 3 |
|---|---|---|---|
| Pressure (mTorr) | 50 | 50 | 50 |
| ICP Power (W) | 2200 | 1500 | 2200 |
| NH₃ (sccm) | 100 | 10 | 10 |
| O₂ (sccm) | 0 | 100 | 100 |
| N₂ (sccm) | 0 | 0 | 10 |
| Temperature (° C.) | −5 | −5 | −5 |

Under all the conditions shown in Table 1, an excellent rate of photoresist removal was observed with no observable damage to either the nozzle roof 21 or the heater element 29. In particular, all the photoresist contained in the nozzle chamber was removed after about 15-30 minutes using the conditions shown in Recipes 2 and 3. By way of comparison, conventional O₂ ashing or O₂/N₂ ashing requires about 70-90 minutes of frontside ashing time to remove the same photoresist.

As expected, the improved ashing rates were also observed in similar backside ashing experiments. Again, the O₂/NH₃ and the O₂/NH₃/N₂ gas chemistries gave the highest ashing rates, although NH₃ only was still superior to O₂ only or O₂/N₂ gas chemistries.

From these experiments, it can be concluded that gas chemistries comprising NH₃ provide superior ashing rates compared to conventional ashing conditions. Moreover, the structural integrity of the MEMS nozzle assemblies is not compromised using these improved ashing conditions.

The best results were obtained using O₂/NH₃ and O₂/N₂/NH₃ gas chemistries. However, NH₃ only is still superior to conventional O₂ ashing conditions.

It will be appreciated by ordinary workers in this field that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of photoresist removal, said method employing a plasma formed from a gas chemistry comprising NH₃.

2. The method of claim 1, wherein said gas chemistry consists of NH₃ only.

3. The method of claim 1, wherein said gas chemistry further comprises O₂.

4. The method of claim 3, wherein a ratio of O₂:NH₃ is in the range of 15:1 to 5:1.

5. The method of claim 1, wherein the gas chemistry consists of O₂ and NH₃.

6. The method of claim 1, wherein said gas chemistry further comprises N₂.

7. The method of claim 6, wherein a ratio of N₂:NH₃ is in the range of 5:1 to 1:5.

8. The method of claim 1, wherein the gas chemistry consists of O₂, NH₃ and N₂.

9. The method of claim 1, wherein a rate of photoresist removal is at least 20% greater than a rate of photoresist removal using an O₂ plasma.

10. The method of claim 1, wherein said photoresist is hardbaked photoresist.

11. The method of claim 1, wherein said photoresist is UV-cured photoresist.

12. The method of claim 1, wherein said photoresist has a thickness of at least 2 microns.

13. The method of claim 1, wherein said photoresist has a thickness of at least 5 microns.

14. The method of claim 1, wherein said method is a step of a MEMS fabrication process.

15. The method of claim 1, wherein said method is a step of a printhead fabrication process.

16. The method of claim 15, wherein said photoresist is contained in at least one of: inkjet nozzle chambers and ink supply channels.

17. The method of claim 15, wherein said photoresist is a protective coating for inkjet nozzle assemblies.

18. A method of fabricating an inkjet printhead, said method comprising the steps of:
forming inkjet nozzle chambers on a substrate, each nozzle chamber containing at least some photoresist; and
removing said photoresist using a plasma formed from a gas chemistry comprising NH₃.
